(19) United States
(12) Patent Application Publication
(10) Pub. No.: US 2024/0429844 A1
(43) Pub. Date: Dec. 26, 2024

(54) MOTOR CONTROL APPARATUS FOR CONTROLLING MOTOR AND IMAGE FORMING APPARATUS

(71) Applicant: CANON KABUSHIKI KAISHA, Tokyo (JP)

(72) Inventor: YUSUKE ISOMI, Kanagawa (JP)

(21) Appl. No.: 18/750,882

(22) Filed: Jun. 21, 2024

(30) Foreign Application Priority Data
Jun. 23, 2023 (JP) 2023-103599

(51) Int. Cl. H02P 21/22; G03G 15/00; H02P 21/18

(52) U.S. Cl. CPC H02P 21/22; G03G 15/5004; G03G 15/6511; G03G 15/6529; G03G 15/80; H02P 21/18

(57) ABSTRACT

A motor control apparatus includes a current supply unit and a control unit. The current supply unit supplies a coil current to a plurality of coils of a motor by controlling a voltage applied to the plurality of coils based on a target value of an excitation current and a target value of a torque current. The control unit sets the target value of the excitation current to a first target value in a first period within a period in which a rotation speed of the motor is controlled to be a target speed, and sets the target value of the excitation current to a second target value larger than the first target value in a second period different from the first period.

### BACKGROUND

### Field

The present disclosure relates to control technology for a motor.

### Description of the Related Art

A sensorless-type motor (hereinafter, referred to as sensorless motor), which is not equipped with a sensor that detects a position of a rotor, is used as a drive source of a rotation member of an image forming apparatus. Japanese Patent Laid-Open No. H08-223970 discloses a configuration in which a sensorless motor is vector controlled.

When a load variation of a motor occurs during the vector control of the motor, a rotation speed of the motor may vary. For example, when a photosensitive member of an image forming apparatus is rotationally driven by the motor, if the rotation speed of the motor varies, a quality of a formed image is affected.

### SUMMARY

According to an aspect of the present disclosure, a motor control apparatus includes a current supply unit configured to supply a coil current to a plurality of coils of a motor by controlling a voltage applied to the plurality of coils based on a target value of an excitation current and a target value of a torque current, and a control unit configured to set the target value of the excitation current to a first target value in a first period within a period in which a rotation speed of the motor is controlled to be a target speed, and to set the target value of the excitation current to a second target value larger than the first target value in a second period different from the first period.

Further features of the present disclosure will become apparent from the following description of exemplary embodiments with reference to the attached drawings.

### BRIEF DESCRIPTION OF THE DRAWINGS

FIG. 1 is a configuration diagram of an image forming apparatus according to some embodiments;

FIG. 2 is a control configuration diagram of the image forming apparatus according to some embodiments;

FIG. 3 is a configuration diagram of a motor control unit according to some embodiments;

FIG. 4 is a functional block diagram implemented by a microcomputer in some embodiments;

FIGS. 5A and 5B are explanatory diagrams of a behavior of a motor when a load varies;

FIG. 6 is an explanatory diagram of an operation of the motor control unit according to an embodiment;

FIG. 7 is a flowchart of processing executed by the motor control unit according to an embodiment;

FIG. 8 is an explanatory diagram of an operation of the motor control unit according to an embodiment;

FIG. 9 is a flowchart of processing executed by the motor control unit according to an embodiment;

FIG. 10 is an explanatory diagram of processing of determining a target value of an excitation current according to an embodiment; and

FIG. 11 is a flowchart of processing executed by the motor control unit according to an embodiment.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made that requires all such features, and multiple such features may be combined as appropriate. Furthermore, in the attached drawings, the same reference numerals are given to the same or similar configurations, and redundant description thereof is omitted.

### First Embodiment

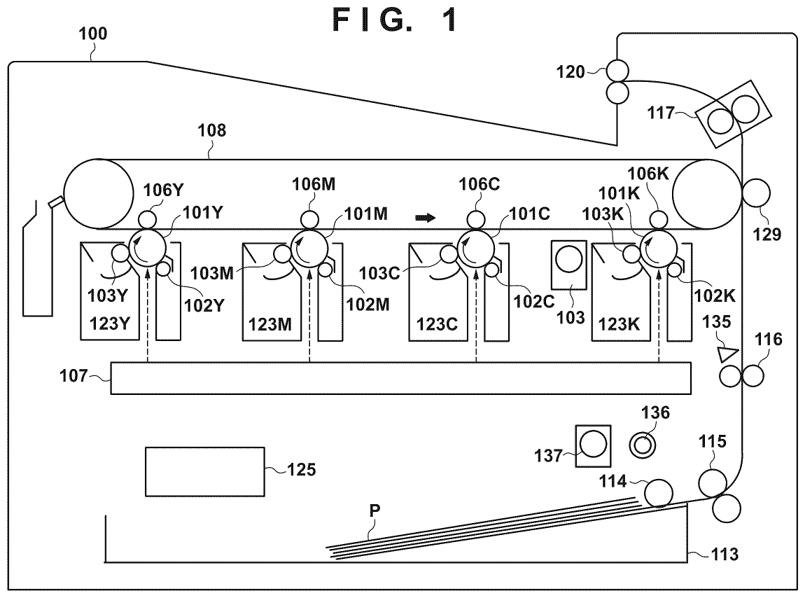

FIG. 1 is a schematic cross-sectional diagram of an image forming apparatus 100 according to the present embodiment. In FIG. 1, characters “Y”, “M”, “C” and “K” are provided at the end of respective reference signs of members relating to image formation of yellow, magenta, cyan and black. Note that in the following description, a reference sign in which the character at the end of the reference sign is omitted will be collectively used. A photosensitive member 101 that is an image carrier is rotationally driven in a clockwise direction in the drawing at image formation. A charging roller 102 charges a surface of the photosensitive member 101. An exposure apparatus 107 exposes each photosensitive member 101 to form an electrostatic latent image on each photosensitive member 101. A developing roller 103 forms a toner image on the photosensitive member 101 by developing the electrostatic latent image on the photosensitive member 101 with toner. The toner is contained in a toner container 123. An intermediate transfer belt 108 that is an image carrier is rotationally driven in a counterclockwise direction in the drawing at image formation. A primary transfer roller 106 transfers the toner image on the photosensitive member 101 to the intermediate transfer belt 108. Note that colors other than yellow, magenta, cyan, and black can be reproduced by superimposing and transferring the toner images of the respective photosensitive members 101 onto the intermediate transfer belt 108.

A feeding roller 114 feeds a sheet P stored in a cassette 113 to a conveyance path. Note that a driving force is transmitted to the feeding roller 114 by a motor (not illustrated) via a clutch 136. The clutch 136 is a switching unit that transmits the driving force of the motor (not illustrated) to the feeding roller 114 in a transmission state and does not transmit the driving force of the motor (not illustrated) to the feeding roller 114 in a disconnected state. The sheet P fed to the conveyance path is conveyed to an opposing position of a secondary transfer roller 129 by a conveying roller 115 and a registration roller 116. Note that a timing at which the registration roller 116 conveys the sheet P to the opposing position of the secondary transfer roller 129 is determined based on a timing at which a conveyance sensor 135 detects the sheet P. The secondary transfer roller 129 transfers the toner images on the intermediate transfer belt 108 to the sheet P. A fixing apparatus 117 includes a heating roller and a pressurizing roller, and heats and pressurizes the sheet P, on which the toner images are transferred, to fix the toner images on the sheet P. After the toner images are fixed, the sheet P is discharged by a discharge roller 120 to the outside of the image forming apparatus 100.

The image forming apparatus 100 includes a conveyance unit that conveys the sheet P and an image forming unit that forms an image on the sheet P that is being conveyed by the conveyance unit. The conveyance unit includes rollers such as the feeding roller 114 as a feeding unit that feeds the sheet P to the conveyance path, and the registration roller 116 and the discharge roller 120 provided along the conveyance path. The image forming unit includes the photosensitive member 101, the charging roller 102, the developing roller 103, the primary transfer roller 106, the secondary transfer roller 129, and the fixing apparatus 117. The conveyance unit and the image forming unit include rotation members such as the photosensitive member 101, the roller of the fixing apparatus 117, the intermediate transfer belt 108, and the registration roller 116. In order to rotationally drive the rotation members, the image forming apparatus 100 includes one or more motors. A motor 137 illustrated in FIG. 1 is a sensorless motor, which drives the photosensitive member 101K and the intermediate transfer belt 108. A control unit 125 controls the image forming apparatus 100.

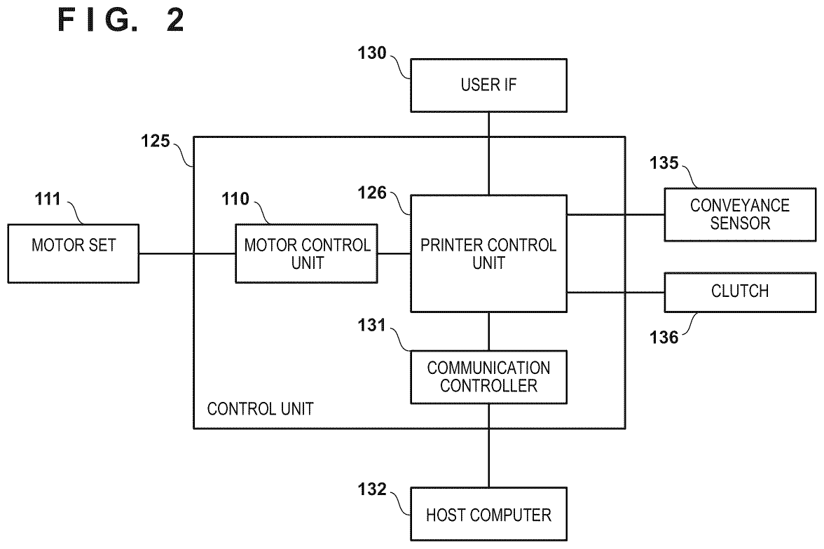

In FIG. 2, functional blocks of the control unit 125 are illustrated. A printer control unit 126 includes one or more processors, one or more volatile and non-volatile memory devices, and the like. The one or more processors execute programs stored in the memory devices to control the image forming apparatus 100 as a whole. Note that, it may also be configured such that a part or all of processing performed by the processor is realized by hardware such as an application specific integrated circuit (ASIC).

The printer control unit 126 communicates with an external host computer 132 via a communication controller 131. The host computer 132 transmits, for example, print data to the printer control unit 126 and causes the image forming apparatus 100 to perform image formation based on the print data. In addition, the printer control unit 126 controls a user interface (IF) 130. The user IF 130 provides an input/output interface for a user to operate the image forming apparatus 100. For example, in forming an image on the sheet P, the printer control unit 126 controls a state of the clutch 136 and a motor set 111 including the motor 137 via a motor control unit 110. Further, based on a detection result of the sheet P by the conveyance sensor 135, the printer control unit 126 determines a timing at which the sheet P is sent to a nip region (transfer region) between the secondary transfer roller 129 and the intermediate transfer belt 108.

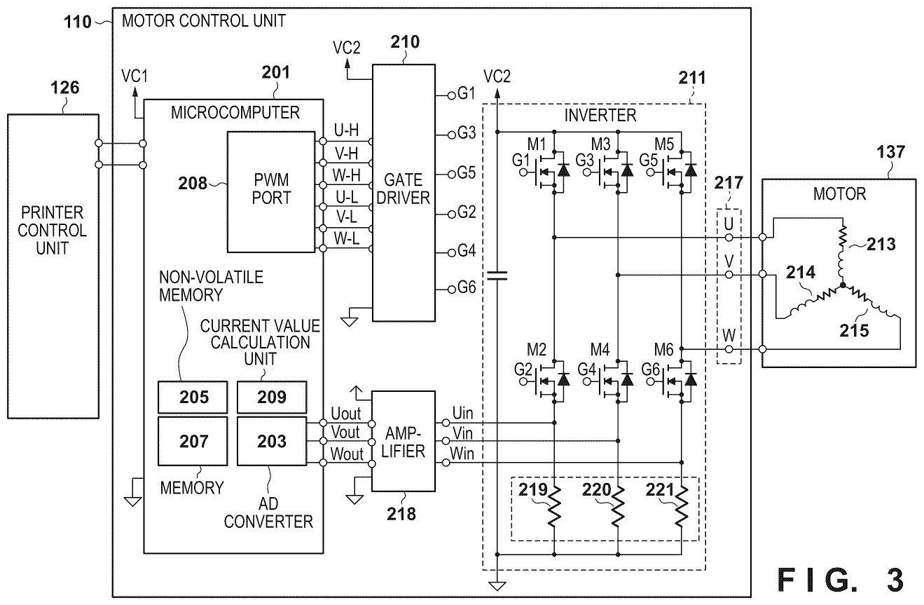

In FIG. 3, a configuration of the motor control unit 110 is illustrated. The motor control unit 110 communicates with the printer control unit 126 and controls the motor 137 under control of the printer control unit 126. A non-volatile memory 205 of a microcomputer 201 stores a program executed by the microcomputer 201 and various kinds of data used for control of the motor 137. A memory 207 is used by the microcomputer 201 for temporary data storage. A PWM port 208 includes a total of six terminals configured to output two PWM signals (high side and low side) with respect to each of three phases (U, V, and W) of the motor 137. That is, the PWM port 208 includes three terminals of the high side (U-H, V-H, and W-H) and three terminals of the low side (U-L, V-L, and W-L).

An inverter 211 includes switching elements M1, M3, and M5 of the high side and switching elements M2, M4, and M6 of the low side, for each of the three phases of the motor 137. In FIG. 3, the switching elements M1 and M2 are U-phase switching elements, the switching elements M3 and M4 are V-phase switching elements, and the switching elements M5 and M6 are W-phase switching elements. As the switching element, for instance, a transistor or an FET can be used. A gate driver 210 controls ON/OFF of the corresponding switching element, based on the PWM signal from the PWM port 208. For instance, the gate driver 210 controls ON/OFF of the switching element M1 by controlling applied voltage to a gate G1 of the switching element M1, based on the PWM signal output from the U-H terminal.

U-phase, V-phase, and W-phase outputs 217 of the inverter 211 are respectively connected to coils 213 (U-phase), 214 (V-phase), and 215 (W-phase) of the motor 137. Coil current flowing through each of the coils 213, 214, and 215 can be controlled by controlling ON/OFF of respective switching elements. In this manner, the inverter 211 functions as a current supply unit that supplies the coil current to each of the coils 213, 214, and 215. The coil currents each flowing through the coils 213, 214, and 215 are respectively converted, by current detection resistors 219, 220, and 221, into a voltage Uin, a voltage Vin, and a voltage Win. The voltage Uin, the voltage Vin, and the voltage Win are voltages respectively corresponding to the U-phase coil current, the V-phase coil current, and the W-phase coil current. An amplifier 218 amplifies the voltage Uin, the voltage Vin, and the voltage Win and outputs a voltage Uout, a voltage Vout, and a voltage Wout to an AD converter 203 of the microcomputer 201. The AD converter 203 converts the voltage output by the amplifier 218 into a digital value. A current value calculation unit 209 measures and detects current values of the U-phase, V-phase, and W-phase coil currents, based on the digital values of the voltage Uout, the voltage Vout, and the voltage Wout output by the AD converter 203.

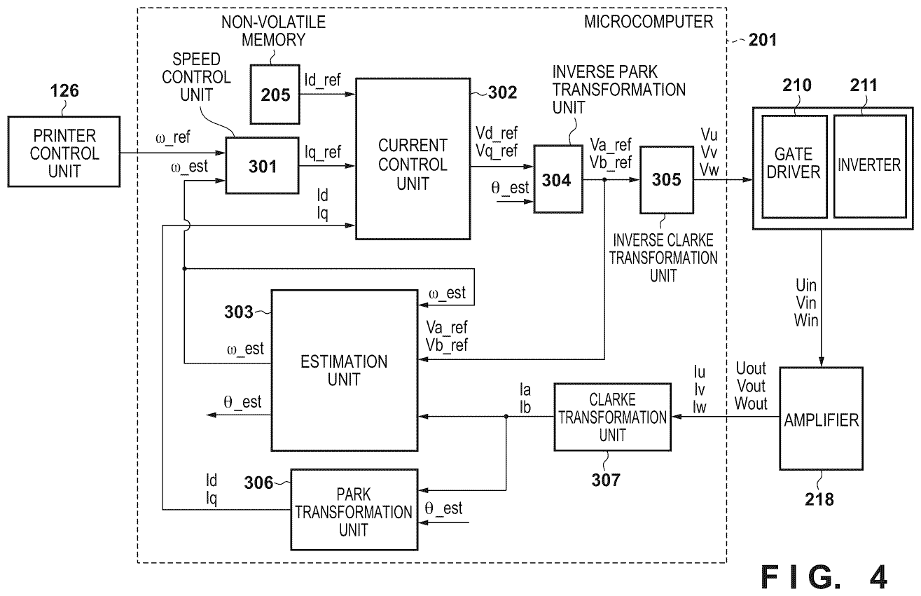

FIG. 4 is a functional block diagram of the microcomputer 201 when the motor 137 is vector controlled. In FIG. 4, an inverse Park transformation unit 304 performs transformation from a rotor coordinate system to a two-phase stator coordinate system, and a Park transformation unit 306 performs transformation from the two-phase stator coordinate system to the rotor coordinate system. The rotor coordinate system is also referred to as a rotating coordinate system, which has a d-axis and a q-axis. Current of the d-axis (d-axis current) contributes to excitation and is also referred to as excitation current. Current of the q-axis (q-axis current) contributes to torque and is also called torque current. The two-phase static coordinate system is also referred to as a static coordinate system which has an a-axis and a b-axis. In addition, in FIG. 4, an inverse Clarke transformation unit 305 performs transformation from the two-phase stator coordinate system (a, b) to three-phase stator coordinate system (U, V, W), and a Clarke transformation unit 307 performs transformation from the three-phase stator coordinate system (U, V, W) to the two-phase stator coordinate system (a, b).

A current control unit 302 acquires a target value Id_ref of the excitation current stored in advance in the non-volatile memory 205. A target value Iq_ref of the torque current is input from a speed control unit 301 to the current control unit 302, and a measured value Id of the excitation current and a measured value Iq of the torque current are input from the Park transformation unit 306 to the current control unit 302. The current control unit 302 outputs voltage target values Vd_ref and Vq_ref in the rotating coordinate system based on the target value Id_ref of the excitation current, the target value Iq_ref of the torque current, the measured value Id of the excitation current, and the measured value Iq of the torque current. The inverse Park transformation unit 304 transforms the voltage target values Vd_ref and Vq_ref in the rotating coordinate system into voltage target values Va_ref and Vb_ref in the static coordinate system. Note that the coordinate transformation in the inverse Park transformation unit 304 is performed based on an electric angle θ_est estimated by an estimation unit 303. The inverse Clarke transformation unit 305 generates and outputs voltage target values Vu, Vv, and Vw of the U phase, the V phase, and the W phase based on the voltage target values Va_ref and Vb_ref. The microcomputer 201 generates a PWM signal to be output to the gate driver 210, based on the voltage target values Vu, Vv, and Vw.

The current value calculation unit 209 of the microcomputer 201, which is omitted in FIG. 4, obtains measured values Iu, Iv, and Iw of the coil currents of the U phase, the V phase, and the W phase based on the voltage Uout, the voltage V out, and the voltage Wout output by the amplifier 218, and outputs the same to the Clarke transformation unit 307. The Clarke transformation unit 307 transforms the measured values Iu, Iv, and Iw into a measured value Ia of the a-axis current and a measured value Ib of the b-axis current. The Park transformation unit 306 transforms the measured value Ia and the measured value Ib in the static coordinate system into the measured value Id and the measured value Iq in the rotating coordinate system. The coordinate transformation in the Park transformation unit 306 is performed based on the electric angle θ_est estimated by the estimation unit 303.

The estimation unit 303 determines an induced voltage generated in the coil, based on the measured values Ia and Ib, the voltage target values Va_ref and Vb_ref, and a rotation speed ω_est being estimated, and estimates an electric angle θ_est and a rotation speed ω_est of a rotor of the motor 137. The speed control unit 301 calculates a target value Iq_ref that causes generation of torque required to cause the rotation speed to follow a speed target value ω_ref (target speed), based on the speed target value ω_ref from the printer control unit 126 and the rotation speed ω_est estimated by the estimation unit 303.

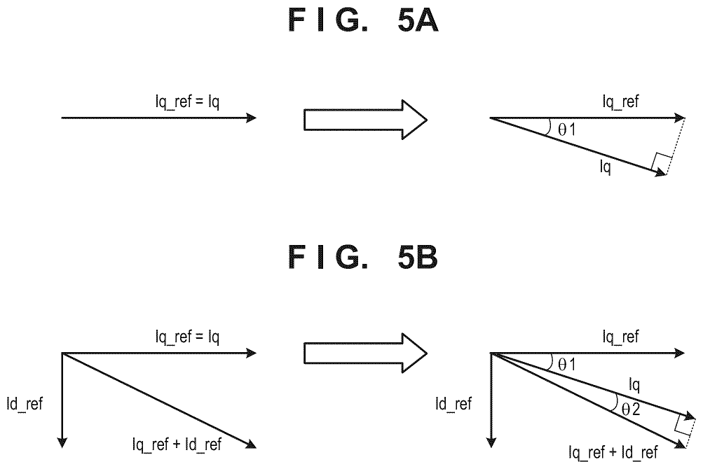

As illustrated on the left side of FIG. 5A, in the vector control, the target value Id_ref of the excitation current that does not contribute to the torque is set to 0, by emphasizing efficiency. When load torque is constant, a rotational phase of the rotor of the motor 137 coincides with a phase (electric angle θ_est) estimated by the estimation unit 303. In this case, the target value Iq_ref of the torque current and the torque current coincide with each other in terms of vector. Note that in FIG. 5A, a rotation direction of the rotor of the motor 137 is set to a counterclockwise direction. On the right side of FIG. 5A, a case is illustrated in which the rotational phase of the rotor deviates from the phase estimated by the estimation unit 303 by an electric angle θ1 due to an increase in the load torque or the like. In this case, a current value of the current acting as the torque current at the target value Iq_ref actually decreases from X to X cos θ1, where X is the target value Iq_ref. Since the value of the actual torque current decreases from the target value Iq_ref in this way, when the speed of the motor 137 varies due to variation in the load torque or the like, a time until the speed of the motor 137 returns to the target speed becomes longer.

For this reason, in the present embodiment, the target value Id_ref of the excitation current is set to a value larger than 0 in a period in which the rotation speed of the motor 137 is controlled to be the target speed, as illustrated in FIG. 5B. On the left side of FIG. 5B, a state is illustrated in which the rotational phase of the rotor coincides with the phase estimated by the estimation unit 303. A composite vector of the target value Id_ref and the target value Iq_ref is indicated as Id_ref+Iq_ref in FIG. 5B, which corresponds to a target value of coil current actually flowing through the coil. On the right side of FIG. 5B, a case is illustrated in which the rotational phase of the rotor deviates from the phase estimated by the estimation unit 303 by an electric angle θ1 due to an increase in the load torque or the like. When the actual rotational phase of the rotor deviates from the phase estimated by the estimation unit 303 by the electric angle θ1, the excitation current based on the target value Id_ref becomes to contribute to the torque. In FIG. 5B, (Iq_ref+Id_ref)cos θ2 is a target value of the current that actually contributes to the torque. In this way, by setting the target value Id_ref to a value larger than 0, it is possible to suppress a decrease in the current contributing to the torque even when a deviation occurs between the actual rotational phase of the rotor and the rotational phase estimated by the estimation unit 303. Therefore, even when the rotation speed of the rotor varies due to the load variation, it is possible to shorten the time until the rotation speed of the rotor returns to the target speed.

However, if Id_ref is always set to a large value to increase the coil current while the motor 137 is rotationally driven, the power efficiency of the motor 137 decreases. In addition, the torque may decrease along with an increase in coil temperature. Therefore, in the present embodiment, a period in which a load variation may occur (hereinafter, referred to as a variation period) is determined based on an image forming sequence, Id_ref is set to a (first target value) in a period (first period) other than the variation period, and Id_ref is set to β (second target value) larger than a in the variation period (second period). Note that a is a value of 0 or larger than 0, and is determined so as to suppress an increase in the coil temperature in consideration of the power efficiency of the motor 137. A start timing and an end timing of the variation period (accordingly, a length of the variation period) are set to include a period from an occurrence of the load variation until a speed change of the motor 137 due to the load variation falls within a predetermined range. Specifically, the start timing and the end timing of the variation period are determined based on an occurrence timing of the load variation, a fluctuation in the occurrence timing, a pattern of the speed change of the motor 137 due to the load variation, and the like. In addition, the value β of Id_ref set in the variation period is also determined based on a magnitude of the load variation that may occur.

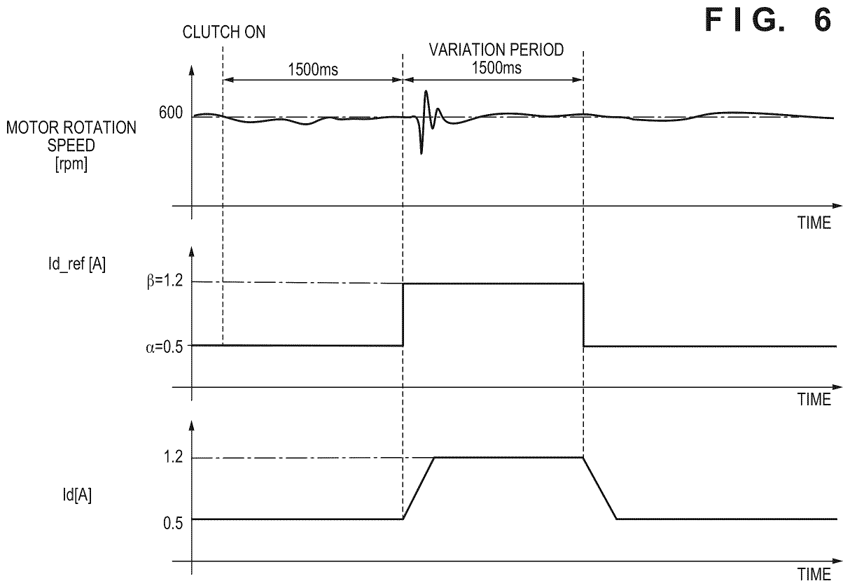

For example, when the sheet P enters the nip region (transfer region) between the intermediate transfer belt 108 and the secondary transfer roller 129, a load of the motor 137 that drives the intermediate transfer belt 108 may vary, and a speed variation of the motor 137 may occur. FIG. 6 is a sequence diagram of processing executed by the motor control unit 110 when a period including a timing at which the sheet P enters the nip region between the intermediate transfer belt 108 and the secondary transfer roller 129 is set as the variation period. Note that in FIG. 6, α is set to 0.5 A, β is set to 1.2 A, and the target value (target speed) of the rotation speed of (the rotor of) the motor 137 is set to 600 rpm. In the present embodiment, the start timing of the variation period is determined based on a timing at which the feeding of the sheet P is started by switching the clutch 136 from the disconnected state to the transmission state. According to FIG. 6, a timing after the 1500 ms from the timing at which the feeding of the sheet P is started is set as the start timing of the variation period. The variation period is also set to 1500 ms. The start timing and the end timing of the variation period, the value of α, and the value of β are stored in advance in the non-volatile memory 205 of the motor control unit 110.

The motor control unit 110 sets the target value Id_ref to 0.5 A until the start timing of the variation period. Then, when it comes to be the start timing of the variation period, the target value Id_ref is changed to 1.2 A. Accordingly, the excitation current Id also increases. The motor control unit 110 sets the target value Id_ref to 0.5 A when it comes to be the end timing of the variation period.

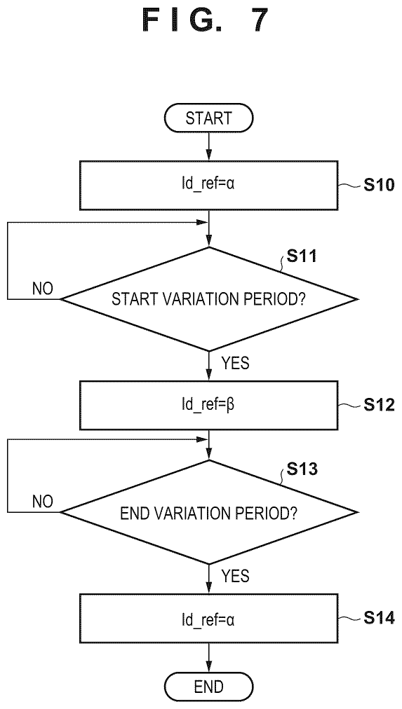

FIG. 7 is a flowchart of processing executed by the motor control unit 110 in the present embodiment. In S10, the motor control unit 110 sets the target value Id_ref to a predetermined value α where the motor 137 is started. Note that, it may be configured such that the target value Id_ref is set to a different value until the motor 137 is started and the motor 137 reaches the target speed, and the target value Id_ref is set to the predetermined value α after the motor 137 reaches the target speed. The value α is a value equal to or larger than 0. In S11, the motor control unit 110 waits until it comes to be the start timing of the variation period. When it comes to be the start timing of the variation period, the motor control unit 110 sets the target value Id_ref to a predetermined value β, in S12. The value β is larger than the value α. In S13, the motor control unit 110 waits until it comes to be the end timing of the variation period. When it comes to be the end timing of the variation period, the motor control unit 110 sets the target value Id_ref to a predetermined value α, in S14.

Note that in the present embodiment, the start timing of the variation period is determined based on the timing at which the clutch 136 is turned on. However, it may be configured such that the start timing of the variation period is determined based on other information. For example, the start timing of the variation period may be determined using a timing at which the conveyance sensor 135 configured to detect the sheet P in the conveyance path on an upstream side from the nip region between the intermediate transfer belt 108 and the secondary transfer roller 129 detects the sheet P. In this case, a timing at which the conveyance sensor 135 detects the sheet P may be set as the start timing of the variation period, or a timing after a predetermined period from the timing at which the conveyance sensor 135 detects the sheet P may be set as the start timing of the variation period.

In addition, although the embodiment has been described by exemplifying the load variation occurring when the sheet P comes into contact with the intermediate transfer belt 108 rotationally driven by the motor 137, the present disclosure can be applied to any load variation occurring in the motor. For example, the load variation may occur at a timing at which the sheet P comes into contact with the rotation member rotationally driven by the motor, or at a timing at which the sheet P in contact with the rotation member rotationally driven by the motor is separated from the rotation member. Further, the load variation may occur at a timing at which the rotation member rotationally driven by the motor and another member of the image forming apparatus 100 come into contact with or separate from each other. For example, the load variation may occur when a contact state in which the photosensitive member 101 and the intermediate transfer belt 108 are in contact with each other and a separation state in which they are separated from each other are switched.

As described above, the second target value β of the excitation current in the variation period (second period) set in advance is set to be larger than the first target value α of the excitation current in the period (first period) different from the variation period. According to this configuration, it is possible to suppress an increase in the period until the rotation speed of the motor returns to the target speed, even when a load variation occurs. That is, the speed variation of the motor can be suppressed. In addition, in the present embodiment, since the first target value α of the excitation current in a period different from the variation period is set to be smaller than the second target value β of the excitation current in the variation period, it is possible to suppress an increase in coil temperature and an increase in power consumption.

### Second Embodiment

In the first embodiment, the length of the variation period is fixedly set. However, the period from when the speed of the motor 137 varies from the target speed to when the speed returns to the target speed may change with time due to time degradation or the like. Therefore, in a case where the variation period is fixed, a situation may occur in which the target value Id_ref is returned from the value β to the value α even though the speed variation is not sufficiently stabilized. Further, in a case where the variation period is fixed, a situation may occur in which the value of the excitation current Id is increased to consume extra power even though the speed variation is sufficiently stabilized. Therefore, in the present embodiment, the length of the variation period is dynamically changed.

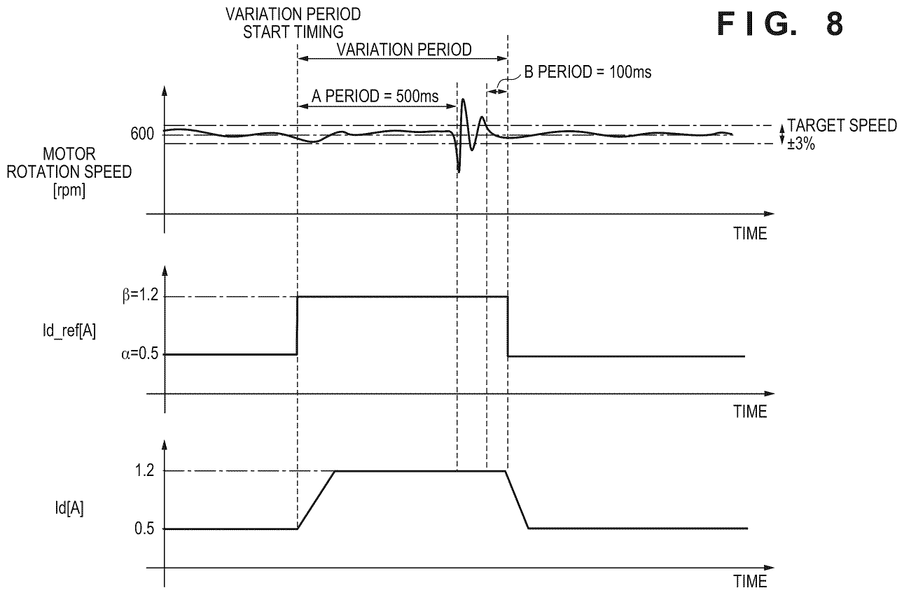

FIG. 8 is a sequence diagram of processing executed by the motor control unit 110 in the present embodiment. In the motor control unit 110, a start timing of the variation period, a length of a period A, and a length of a period B are set in advance. The period A is a predetermined period that starts from the start timing of the variation period. The period A is set to include a timing at which the load variation occurs. In the example of FIG. 8, the length of the period A is set to 500 ms. The period B is a period for confirming that the speed variation is stabilized, and is determined based on the assumed load torque and the target speed of the motor 137. A period between the period A and the period B is a variable period.

As in the first embodiment, when it comes to be the start timing of the variation period, the motor control unit 110 sets the value of Id_ref to β and only waits for the period A. When the period A has elapsed, the motor control unit 110 monitors a speed variation amount and determines whether the speed variation amount falls within a predetermined range. The speed variation amount is an index indicating a difference between the rotation speed of the motor 137 and the target speed, and may be, for example, a difference between the rotation speed and the target speed or a ratio of the difference to the target speed. In FIG. 8, the predetermined range is set to a range in which the ratio of the difference between the rotation speed and the target speed to the target speed is within ±3%. When the speed variation amount continues to be within the predetermined range for the period B, the motor control unit 110 determines that the variation period has ended and sets the value of Id_ref to α.

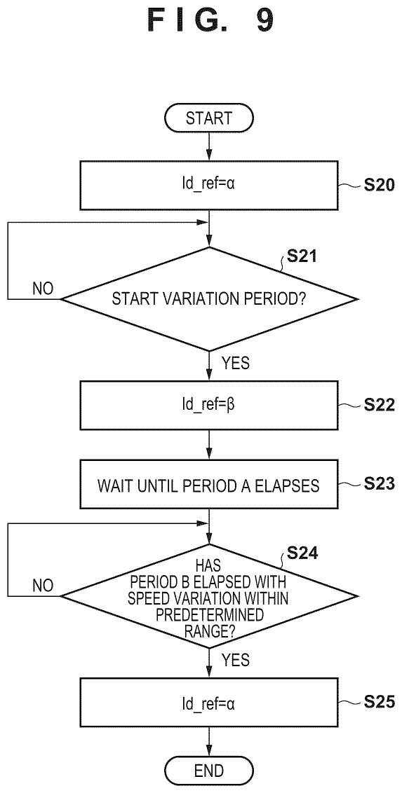

FIG. 9 is a flowchart of processing executed by the motor control unit 110 in the present embodiment. In S20, the motor control unit 110 sets the target value Id_ref to a predetermined value α at the time of start of the motor 137 or after the rotation speed of the motor 137 reaches the target speed. The value α is a value equal to or larger than 0. In S21, the motor control unit 110 waits until it comes to be the start timing of the variation period. When it comes to be the start timing of the variation period, the motor control unit 110 sets the target value Id_ref to a predetermined value β, in S22. In S23, the motor control unit 110 waits until the period A ends. When the period A has elapsed, the motor control unit 110 waits until the speed variation amount continues to be within the predetermined range for the period B, in S24. When the speed variation amount continues to be within the predetermined range for the period B, the motor control unit 110 sets the target value Id_ref to a predetermined value α, in S25.

As described above, in the present embodiment, the length of the variation period is dynamically determined. Therefore, it is possible to suppress the value of the target value Id_ref from being returned to a even though the speed variation is not reduced, or to suppress the value of the target value Id_ref from being kept at β even though the speed variation is stabilized. Therefore, the speed variation of the motor can be suppressed, and the increase in coil temperature and the increase in power consumption can also be suppressed.

### Third Embodiment

Next, a third embodiment will be described focusing on differences from the first and second embodiments. In the first embodiment and the second embodiment, the value β of the target value Id_ref in the variation period is a fixed value. For example, if the value β is larger than necessary, extra power consumption occurs. In the present embodiment, the value of the target value Id_ref is controlled in accordance with the speed variation amount in the variation period.

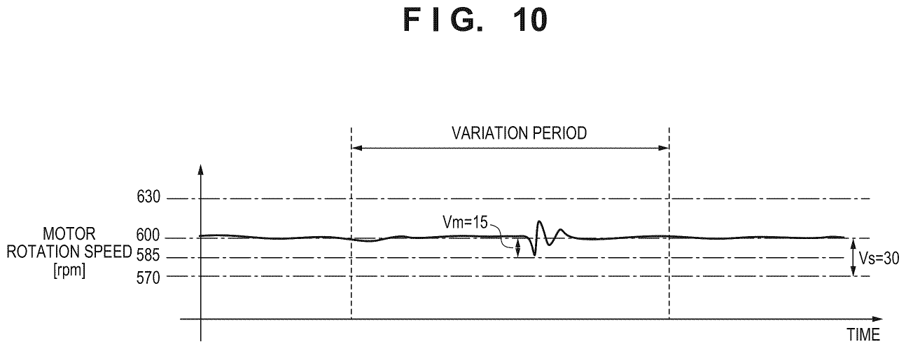

FIG. 10 is an explanatory diagram of the present embodiment. For example, a reference value Vs of a speed variation amount with respect to a target speed of the motor 137 is set. In FIG. 10, the reference value Vs is set to 30. The reference value Vs is set such that even when the speed of the motor 137 varies from the target speed by the reference value Vs, an influence on a formed image is within an allowable range. That is, in the example of FIG. 10, when the speed of the motor 137 is within a range of 570 rpm to 630 rpm, a quality of a formed image is within the allowable range. The motor control unit 110 determines a speed variation amount Vm of the motor 137 when the target value Id_ref is made larger than a in the variation period. In this example, the speed variation amount Vm is the maximum value of an absolute value of a difference between the rotation speed of the motor 137 and the target speed. The motor control unit 110 updates the target value Id_ref based on the measured speed variation amount Vm and the reference value Vs.

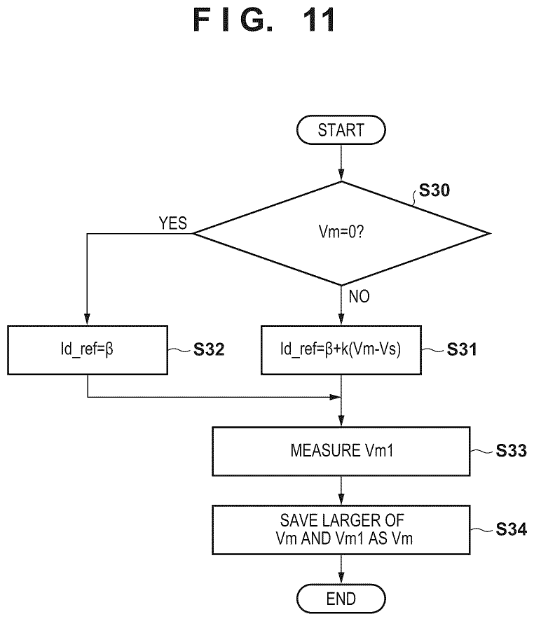

FIG. 11 is a flowchart of processing executed by the motor control unit 110 to update the target value Id_ref. Note that in FIG. 11, an initial value of the speed variation amount Vm stored in advance in the non-volatile memory 205 of the motor control unit 110 is set to 0. The fact that the value of the speed variation amount Vm stored in the non-volatile memory 205 is 0 indicates that the motor control unit 110 has not measured the speed variation amount Vm even once.

In S30, the motor control unit 110 determines whether the value of the speed variation amount Vm stored in the non-volatile memory 205 is 0. When the value of the speed variation amount Vm is 0, the motor control unit 110 sets, in S32, the value of Id_ref to β that is set in a next variation period. The value β is stored in advance in the motor control unit 110.

When the value of the speed variation amount Vm stored in the non-volatile memory 205 is not 0, the motor control unit 110 sets, in S31, the value of Id_ref to be set in the next variation period, based on following Formula (1).

$$Id\_ref = β + k ( Vm\_Vs ) \qquad ( 1 )$$

The value k is a coefficient larger than 0 and is stored in advance in the non-volatile memory 205 of the motor control unit 110. In a next variation period S33, the motor control unit 110 sets the value determined in S31 or S32 as the value of Id_ref. Then, the motor control unit 110 measures a speed variation amount Vm1 in this variation period. In S34, the motor control unit 110 stores, in the non-volatile memory 205 as the updated speed variation amount Vm, the larger one of the speed variation amount Vm stored in the non-volatile memory 205 and the speed variation amount Vm1 measured in S33.

For example, it is assumed that β=1.6, k=0.03, and Vm stored in the non-volatile memory 205 is 10. Note that Vs is 30 as illustrated in FIG. 10. In this case, in the next first variation period, the motor control unit 110 sets 1.6+0.03(10−30)=1 as the value of Id_ref. It is also assumed that the speed variation amount Vm1 measured in the first variation period is 15 as illustrated in FIG. 10. In this case, the motor control unit 110 stores 15 in the non-volatile memory 205 as the speed variation amount Vm, in S34. Therefore, in the second variation period subsequent to the first variation period, the motor control unit 110 sets 1.6+0.03 (15−30)=1.15 as the value of Id_ref.

As is clear from Formula (1), the target value Id_ref increases as the value of the speed variation amount Vm increases. For example, when the speed variation amount Vm is larger than the reference value Vs, the speed variation amount Vm is out of the allowable range. Therefore, the motor control unit 110 displays on the user IF 130, via the printer control unit 126, that the speed variation amount Vm is out of the allowable range.

Note that although the value of Id_ref in the next variation period is determined every variation period in FIG. 11, it may be configured such that the value of Id_ref is determined in each of a plurality of variation periods. In this case, the motor control unit 110 records the maximum value of the speed variation amount Vm1 in each of the plurality of variation periods, and determines the value of Id_ref based on the maximum value.

As described above, in the present embodiment, the target value Id_ref in the variation period is controlled based on the speed variation amount. According to this configuration, the target value Id_ref can be appropriately set. Therefore, the speed variation of the motor can be suppressed, and the increase in coil temperature and the increase in power consumption can also be suppressed.

### MISCELLANEOUS

Note that in each of the above-described embodiments, the motor control unit 110 is described as a component of the image forming apparatus 100, but the motor control unit 110 can be a motor control apparatus as one apparatus. Alternatively, an apparatus including the printer control unit 126 and the motor control unit 110 can be a motor control apparatus. Additionally, the above-described embodiments can be applied to control of a motor that drives an arbitrary rotation member in the image forming apparatus.

Furthermore, the embodiments have been described in which the motor 137 is a sensorless motor that does not include a sensor configured to detect the rotational phase of the rotor. However, the present disclosure is also applicable to vector control of a motor including a sensor configured to detect a rotational phase of a rotor. Even in such a motor, the speed variation can be suppressed by increasing the target value of the excitation current in the period including the timing of the load variation determined based on the image sequence or the like.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-103599, filed Jun. 23, 2023, which is hereby incorporated by reference herein in its entirety.

What is claimed is:

1. A motor control apparatus comprising:
a current supply unit configured to supply a coil current to a plurality of coils of a motor by controlling a voltage applied to the plurality of coils based on a target value of an excitation current and a target value of a torque current; and
a control unit configured to set the target value of the excitation current to a first target value in a first period within a period in which a rotation speed of the motor is controlled to be a target speed, and to set the target value of the excitation current to a second target value larger than the first target value in a second period different from the first period.

2. The motor control apparatus according to claim 1, wherein the second period is a period including a timing at which a load of the motor varies.

3. The motor control apparatus according to claim 2, wherein the second period is a predetermined period.

4. The motor control apparatus according to claim 3, further comprising a storage unit configured to store information indicating the second period.

5. The motor control apparatus according to claim 2, wherein the control unit is further configured to update the second target value based on a speed variation of the rotation speed of the motor with respect to the target speed in the second period.

6. The motor control apparatus according to claim 5, wherein the control unit is further configured to update the second target value such that the second target value increases as the speed variation increases.

7. The motor control apparatus according to claim 1, wherein the control unit is further configured to determine that the second period has ended when a speed variation of the rotation speed of the motor with respect to the target speed continues to be within a predetermined range for a second predetermined period, after a first predetermined period has elapsed since the target value of the excitation current is set to the second target value by start of the second period.

8. The motor control apparatus according to claim 7, wherein the first predetermined period is a period including a timing at which a load of the motor varies.

9. The motor control apparatus according to claim 1, wherein the first target value is a value of 0 or larger than 0.

10. The motor control apparatus according to claim 1, wherein the motor is a sensorless motor that is not provided with a sensor configured to detect a rotational phase of a rotor.

11. An image forming apparatus comprising:
a conveyance unit configured to convey a sheet along a conveyance path;
an image forming unit configured to form an image on the sheet conveyed by the conveyance unit;
a motor configured to rotationally drive a rotation member of the conveyance unit or the image forming unit; and
a motor control apparatus configured to control the motor,
wherein the motor control apparatus includes:
a current supply unit configured to supply a coil current to a plurality of coils of the motor by controlling a voltage applied to the plurality of coils based on a target value of an excitation current and a target value of a torque current, and
a control unit configured to set the target value of the excitation current to a first target value in a first period within a period in which a rotation speed of the motor is controlled to be a target speed, and to set the target value of the excitation current to a second target value larger than the first target value in a second period different from the first period.

12. The image forming apparatus according to claim 11, wherein the second period includes a timing at which the rotation member rotationally driven by the motor and the sheet come into contact with each other or a timing at which the rotation member rotationally driven by the motor and the sheet are separated from each other.

13. The image forming apparatus according to claim 12, further comprising a detection unit configured to detect the sheet in the conveyance path on an upstream side with respect to a position where the sheet comes into contact with the rotation member rotationally driven by the motor,
wherein the control unit is further configured to set a timing at which the detection unit detects the sheet as a start timing of the second period, or is further configured to determine a start timing of the second period based on the timing at which the detection unit detects the sheet.

14. The image forming apparatus according to claim 11, wherein the second period includes a timing at which the rotation member rotationally driven by the motor comes into contact with a member of the image forming apparatus different from the rotation member, or a timing at which the rotation member rotationally driven by the motor separates from the member of the image forming apparatus different from the rotation member.

15. The image forming apparatus according to claim 11, wherein the conveyance unit includes a feeding unit configured to feed a sheet to the conveyance path, and the control unit is further configured to determine a start timing of the second period based on a timing at which a sheet is fed to the conveyance path.

16. The image forming apparatus according to claim 11,
wherein the conveyance unit includes a feeding unit configured to feed a sheet to the conveyance path, and a switching unit configured to switch between a transmission state in which a driving force of the motor is transmitted to the feeding unit and a disconnected state in which the driving force of the motor is not transmitted to the feeding unit, and
wherein the control unit is further configured to determine a start timing of the second period based on a timing at which the switching unit is switched from the transmission state to the disconnected state.
